(19) United States
(12) Patent Application Publication
(10) Pub. No.: US 2021/0108996 A1
(43) Pub. Date: Apr. 15, 2021

(54) AUTOMATIC SLIDE STAINING AND COOLING SYSTEMS

(71) Applicant: X-Zell Inc., Sunnyvale, CA (US)

(72) Inventors: Sebastian Chakrit Punyaratabandhu Bhakdi, Tanjong Pagar (SG); Jay Vichayavichien, Bangkok (TH)

(21) Appl. No.: 16/499,295

(22) PCT Filed: Apr. 20, 2017
(86) PCT No.: PCT/US17/28531

§ 371 Date: Sep. 29, 2019

Related U.S. Application Data
(60) Provisional application No. 62/479,471, filed on Mar. 31, 2017.

(51) Int. Cl. G01N 1/31; G01N 35/10

(52) U.S. Cl. CPC G01N 1/31; G01N 2035/00138; G01N 35/1002

(57) ABSTRACT

A system for automatically staining slides includes a slide management subsystem, a reagent management subsystem, and a fluid dispenser configured to uptake the reagent from the receptacle and dispense the reagent to the slide. The slide management subsystem may include a slide holder configured to receive a slide and a first cooling unit configured to maintain the slide at a temperature between −1° C. and −3° C. In some embodiments, the slide holder comprises a material configured to maintain the temperature between −1° C. and −3° C. The reagent management subsystem may include a rotatable support configured to receive a receptacle holding a reagent, and a second cooling unit configured to maintain the reagent at a temperature between −1° C. and 6° C.

### CROSS-REFERENCE TO RELATED APPLICATIONS

This application claims priority to U.S. Provisional Patent Application Ser. No. 62/479,471, entitled “Automatic Slide Staining and Cooling Systems,” filed Mar. 31, 2017, the disclosure of which is herein incorporated by reference in its entirety.

### INCORPORATION BY REFERENCE

All publications and patent applications mentioned in this specification are herein incorporated by reference in their entirety, as if each individual publication or patent application was specifically and individually indicated to be incorporated by reference in its entirety.

### TECHNICAL FIELD

This disclosure relates generally to the fields of slide preparation and biological sample preparation, and more specifically to slide staining and fixing systems and methods.

### BACKGROUND

Current automatic slide staining and cooling systems maintain the slides or biological samples at room temperature or ambient temperature. However, complex staining and fixing protocols may require the slides to be maintained at well-below freezing temperatures or at least below refrigeration temperatures. In some cases, liquid nitrogen can be used, but liquid nitrogen dissipates rapidly, is volatile, and does not necessarily maintain a reliable temperature making liquid nitrogen unsuitable for precious biological samples. Further, complex staining and fixing protocols may require a variety of temperatures at various stages of the protocol, requiring manual movement of the slides between environments (e.g., fridge, ice, liquid nitrogen, bench top, etc.) that are inherently less temperature controlled.

Based on the foregoing, there is a need for automatic slide staining and cooling systems in the fields of slide preparation and biological sample preparation.

### BRIEF DESCRIPTION OF THE DRAWINGS

The foregoing is a summary, and thus, necessarily limited in detail. The above-mentioned aspects, as well as other aspects, features, and advantages of the present technology are described below in connection with various embodiments, with reference made to the accompanying drawings.

FIG. 1A depicts a perspective view of one embodiment of a kit for preparation of a slide.

FIG. 1B depicts a perspective view of one embodiment of a kit for preparation of a slide.

FIG. 2 depicts a front perspective view of one embodiment of a system for automatically staining slides.

FIG. 3 depicts a rear perspective view of one embodiment of a system for automatically staining slides.

FIG. 4 depicts a top view of one embodiment of a system for automatically staining slides.

FIG. 5 depicts an exploded view of one embodiment of a system for automatically staining slides.

FIG. 6A depicts an exploded view of one embodiment of a slide management subsystem.

FIG. 6B depicts an exploded view of one embodiment of a slide management subsystem.

FIG. 7 depicts an exploded view of one embodiment of a reagent management subsystem.

FIG. 8 depicts a diagram of one embodiment of a rotation function of a slide rotatable support.

FIG. 9 depicts a diagram of one embodiment of a rotation function of a reagent rotatable support.

FIG. 10 depicts a diagram of one embodiment of a motion of a fluid dispenser.

FIG. 11A depicts a front perspective view of one embodiment of a slide clip matingly receiving a slide.

FIG. 11B depicts a front view of one embodiment of a slide clip coupled to a slide.

FIG. 11C depicts a rear view of one embodiment of a slide clip coupled to a slide.

FIG. 11D depicts a cross-sectional view of one embodiment of a slide clip coupled to a slide.

FIG. 12 depicts a perspective view of one embodiment of a slide holder matingly receiving a slide clip coupled to a slide.

FIG. 13A depicts a front view of one embodiment of a slide holder coupled to a slide clip.

FIG. 13B depicts a cross-sectional view of one embodiment of a slide holder coupled to a slide clip.

FIG. 13C depicts a rear view of one embodiment of a slide holder coupled to a slide clip.

FIG. 14A depicts a rear perspective view of one embodiment of a manual slide staining apparatus.

FIG. 14B depicts a front perspective view of one embodiment of an open manual slide staining apparatus.

FIG. 14C depicts an interior view with a housing removed of one embodiment of a manual slide staining apparatus.

FIG. 14D depicts an exploded view of one embodiment of a manual slide staining apparatus.

FIG. 15 depicts a top perspective view of one embodiment of an apparatus for automatically cooling a slide.

FIG. 16 depicts an exploded view of one embodiment of an apparatus for automatically cooling a slide.

FIG. 17 depicts a diagram of one embodiment of a container.

FIG. 18A depicts a diagram of one embodiment of a display.

FIG. 18B depicts a table of one embodiment of a plurality of optical indicators on the display shown in FIG. 18A.

FIG. 19 depicts a flow diagram of one embodiment of a method of using an automatic slide staining system.

The illustrated embodiments are merely examples and are not intended to limit the disclosure. The schematics are drawn to illustrate features and concepts and are not necessarily drawn to scale.

### SUMMARY

One aspect of the present disclosure is directed to a system for automatically staining slides. In some embodiments, the system includes: a slide management subsystem including: a slide holder configured to receive a slide, a first rotatable support coupled to the slide holder, such that the first rotatable support comprises a first material configured to retain a temperature between −1° C. and −3° C., and a first cooling unit configured to maintain the slide at a temperature between −1° C. and −3° C.; a reagent management subsystem including: a second rotatable support configured to receive a receptacle holding a reagent, and a second cooling unit configured to maintain the reagent at a temperature between −2° C. and 6° C. or −1° C. and 6° C.; and a fluid dispenser configured to uptake the reagent from the receptacle and dispense the reagent to the slide.

In some embodiments, the slide holder is sized and shaped to receive a slide clip coupled to the slide. In some embodiments, the slide clip is configured to create a capillary gap between the slide slip and the slide. In some embodiments, a gap between the slide clip and the slide is between 50 and 200 micrometers.

In some embodiments, the slide holder comprises a second material configured to maintain the slide at a temperature between −1° C. and −3° C. In some embodiments, one or both of the first material and the second material is formed of or includes one or more of: copper, aluminum, steel, iron, and porcelain.

In some embodiments, the fluid dispenser is moveable between the second rotatable support and the first rotatable support to deliver the reagent to the slide.

In some embodiments, the system further includes a housing. In some embodiments, the slide management subsystem and the reagent management subsystem are positionable within the housing.

In some embodiments, the first cooling unit includes a compressor.

In some embodiments, the second cooling unit includes a thermoelectric cooler.

In some embodiments, the first rotatable support is rotatable 18.95° in 0.3 seconds.

In some embodiments, the second rotatable support is rotatable 40° in 0.3 seconds.

In some embodiments, one or both of the first rotatable support and the second rotatable support includes a carousel.

In some embodiments, the fluid dispenser is configured to align with a longitudinal axis of the slide when the slide is positioned in the slide holder.

In some embodiments, the slide management subsystem further includes one or more additional slide holders coupled to the first rotatable support, such that each additional slide holder is configured to receive an additional slide.

In some embodiments, the second rotatable support includes a pocket configured to receive the receptacle.

In some embodiments, the system further includes: a processor communicatively coupled to the fluid dispenser, the first rotatable support, and the second rotatable support; and a computer-readable medium having non-transitory, processor-executable instructions stored thereon, such that execution of the instructions causes the processor to perform a method including: receiving a user input to initiate a cell staining protocol; uptaking the reagent from the second rotatable support; dispensing the reagent to the slide; and incubating the slide with the reagent for a pre-determined period of time.

In some embodiments, the method executed by the processor further includes repeating: uptaking, dispensing, and incubating until the cell staining protocol is complete.

In some embodiments, the method executed by the processor further includes rotating the first rotatable support to align a second slide with the fluid dispenser.

In some embodiments, the method executed by the processor further includes rotating the second rotatable support to align a second reagent with the fluid dispenser.

In some embodiments, the method executed by the processor further includes moving the fluid dispenser between the second rotatable support and the first rotatable support.

In some embodiments, the method further includes a display configured to receive the user input.

Another aspect of the present disclosure is direct to an apparatus for automatically cooling a slide. In some embodiments, the apparatus includes: a first cooling platform including: a first aperture configured to receive a first container, and a first cooling element configured to maintain a temperature of the first platform between 0° C. and −10° C.; a second cooling platform including: a second aperture configured to receive a second container, and a second cooling element configured to maintain a temperature of the second platform between −15° C. and −40° C.; and a display configured to display a status of one or more of the first aperture and the second aperture.

In some embodiments, the apparatus further includes the first and second containers. In some embodiments, one or both of the first aperture and the second aperture includes a sensor to detect a presence of the first container or the second container. In some embodiments, one or both of the first container and the second container includes a sensor to detect a presence of a first slide or a second slide positioned therein.

In some embodiments, the first cooling element includes one of a thermoelectric cooler and a compressor.

In some embodiments, the second cooling element includes one or more thermoelectric coolers.

In some embodiments, one or more of the first cooling platform and the second cooling platform includes or is formed of one or more of: aluminum, metal, iron, steel, copper, and porcelain.

In some embodiments, the apparatus further includes a housing. In some embodiments, the first and second cooling platforms are positionable within the housing.

In some embodiments, the first and second containers are configured to receive a fixative therein.

In some embodiments, the first and second containers are watertight.

In some embodiments, the first and second containers are disposable.

In some embodiments, the display includes one or more optical indicators configured to display the status of one or more of the first container and the second container.

In some embodiments, the one or more optical indicators undergo one or more of: a change in activation status, a change in color, and a change in frequency of flashing to indicate the status of the one or more of the first container and the second container.

In some embodiments, the apparatus further includes a speaker configured to emit an acoustic signal indicative of a status of one or more of the first container and the second container. In some embodiments, a frequency or a strength of the acoustic signal emitted by the speaker is configured to change in response to a length of time that one or more of the first container and the second container remains in the apparatus.

### DETAILED DESCRIPTION

The foregoing is a summary, and thus, necessarily limited in detail. The above mentioned aspects, as well as other aspects, features, and advantages of the present technology will now be described in connection with various embodiments. The inclusion of the following embodiments is not intended to limit the disclosure to these embodiments, but rather to enable any person skilled in the art to make and use the contemplated invention(s). Other embodiments may be utilized and modifications may be made without departing from the spirit or scope of the subject matter presented herein. Aspects of the disclosure, as described and illustrated herein, can be arranged, combined, modified, and designed in a variety of different formulations, all of which are explicitly contemplated and form part of this disclosure.

In the FIGURES, the same element numbers are used to refer to like elements unless otherwise specified.

Disclosed herein are systems and methods for preparing a slide for microscopy or other analysis. Biological material may be adhered to the slide. The biological material may include a cell or a plurality of cells, a tissue biopsy, a tissue section, a tissue or cell fragment, or any biological material. The biological material may originate from a plant, animal, mammal, human, bacteria, yeast, fungi, protozoa, eukaryote, prokaryote, or any other tissue or cell source.

The systems and methods described herein may be used in a clinic, research laboratory, diagnostic laboratory, histology laboratory, or any other facility that prepares, analyzes, transfers, submits, or otherwise manipulates slides or biological material.

The biological material may be adhered to the slide using a fixative, for example paraformaldehyde, formaldehyde, ethanol, methanol, a hydrophilic polymer diluted in alcohol with chrome alum, a hydrophilic polymer diluted in alcohol without chrome alum, or any other fixative known in the art. In some embodiments, the biological material is fixed and adhered to the slides using two separate fixatives, for example a first fixing buffer including at least 3% w/v of a first hydrophilic polymer diluted in an alcohol; and a second fixing buffer including at least 5% v/v of a second hydrophilic polymer, at least 0.01% v/v of a detergent, and at least 0.005% w/v of a chrome alum, as described in copending International Patent Application Serial No. PCT/US2017/020905, entitled “Compositions and Methods for Identifying Rare Cells,” filed Mar. 6, 2017, the disclosure of which is incorporated herein by reference in its entirety.

Described herein are systems and methods for automatically staining biological material adhered to a slide. Staining may include immunofluorescence staining, immunohistochemistry, in situ hybridization, or any other staining technique. Staining may include: direct staining; indirect staining; or staining with antibodies, Fc fragments, dyes, intercalating agents, fluorophore tagged reagents, complementary RNA or DNA sequences (i.e., hybridization techniques), or any other chemical, fluorophore, dye, or otherwise macroscopically or microscopically visible reagent.

Described herein are systems and methods for automatically maintaining a slide at a fixed temperature. Individual slides or containers of slides may be individually maintained at a temperature that is different than a plurality of other slides or containers of slides. The systems and methods may regulate a temperature of the slide or container and/or notify a user when the slide temperature is different than a desired temperature or when an incubation period has initiated or expired.

In some embodiments, the systems and apparatuses described herein are configured to be used with one or more staining and fixation methods described in co-pending International Patent Application Serial No. PCT/US2017/020905, entitled “Compositions and Methods for Identifying Rare Cells,” filed Mar. 6, 2017, the disclosure of which is incorporated herein by reference in its entirety.

Such compositions and methods for identifying rare cells rely, in part, on sub-freezing temperatures to maintain the integrity of the biological samples during fixing and staining.

For example, the systems and apparatuses described herein may be used with a reagent system for fixing biological samples. In some embodiments, the reagent system includes: a first fixing buffer (i.e., extracellular fixative) comprising: at least 3% w/v of a first hydrophilic polymer diluted in an alcohol; and a second fixing buffer (i.e., intracellular fixative) comprising: at least 5% v/v of a second hydrophilic polymer, at least 0.01% v/v of a detergent, and at least 0.005% w/v of a chrome alum. In some embodiments, the second hydrophilic polymer, detergent, and chrome alum are diluted in saline. In some embodiments, the first fixing buffer is applied to the biological sample at a temperature colder than −5° C. In some embodiments, the second fixing buffer is applied to the biological sample at a temperature colder than or less than 4° C. In some embodiments, the second fixing buffer is applied to the biological sample at a temperature less than 1° C. In some embodiments, the second fixing buffer is applied to the biological sample at a temperature less than 0° C. In some embodiments, the second fixing buffer is applied to the biological sample at a temperature less than −2° C. In some such embodiments, a cooling apparatus as described elsewhere herein may be used to maintain the biological sample on a slide in the first fixing buffer at a temperature colder than −5° C. and the biological sample on a slide in the second fixing buffer at a temperature colder than or less 4° C., temperature less than 1° C., temperature less than 0° C., or temperature less than −2° C.

In another embodiment, the reagent system includes: a first fixing buffer comprising: 3% to 20% w/v of a first hydrophilic polymer diluted in an alcohol; and a second fixing buffer comprising: 5% to 30% v/v of a second hydrophilic polymer, 0.01% to 1% v/v of a detergent, and 0.005% to 1% w/v of a chrome alum. In some embodiments, the second hydrophilic polymer, detergent, and chrome alum are diluted in saline. In some embodiments, the first fixing buffer is applied to the biological sample at a temperature between −90° C. and −5° C. In some such embodiments, a cooling apparatus as described elsewhere herein may be used to maintain the biological sample on a slide at a temperature between −90° C. and −5° C.

In another embodiment, the reagent system includes: a first fixing buffer comprising: 5% w/v of a first hydrophilic polymer diluted in an alcohol; and a second fixing buffer comprising: 15% v/v of a second hydrophilic polymer, 0.4% v/v of a detergent, and 0.01% w/v of a chrome alum. In some embodiments, the second hydrophilic polymer, detergent, and chrome alum are diluted in saline. In some embodiments, the first fixing buffer is applied to the biological sample at a temperature colder than −15° C. In some such embodiments, a cooling apparatus as described elsewhere herein may be used to maintain the biological sample on a slide at a temperature colder than −15° C.

The first hydrophilic polymer may be one of: polyvinylpyrrolidone and glycerol. The second hydrophilic polymer may be one of: glycerol and polyvinylpyrrolidone. In some embodiments, the alcohol is methanol. In some embodiments, the detergent is a polysorbate surfactant. In some embodiments, the detergent is polysorbate 20. In some embodiments, the first and second hydrophilic polymer are the same. In other embodiments, the first and second hydrophilic polymer are different.

In another embodiment, the reagent includes: at least 3% w/v of a hydrophilic polymer diluted in an alcohol. In some embodiments, the reagent is applied to the biological sample at a temperature colder than −5° C. In some such embodiments, a cooling apparatus as described elsewhere herein may be used to maintain the biological sample on a slide at a temperature colder than −5° C. In some embodiments, the biological sample is a circulating tumor cell. In some embodiments, the biological sample is embedded in a tissue section.

Further for example, the automatic slide staining system described elsewhere herein may be used to automatically stain a biological sample adhered to a slide. Such staining may include immunofluorescence staining, immunohistochemistry, in situ hybridization, or any other staining technique. In some embodiments, staining includes tagging a biological sample with an unlabeled or protein-conjugated (e.g., biotin) primary antibody that recognizes a protein or nucleic acid of interest and labeling the primary antibody with a labeled (e.g., fluorophore) or enzymatically-active (e.g., streptavidin) secondary antibody that recognizes the primary antibody. In some embodiments, staining includes labeling the biological sample with a labeled primary antibody that recognizes a protein or nucleic acid of interest. The label may include: a fluorophore, an enzyme (e.g., streptavidin, horseradish peroxidase, etc.), a bioluminescent molecule, or any other type of label that can be visualized microscopically. In some embodiments, automatically staining the biological sample occurs at a temperature of less than 0° C. In some embodiments, automatically staining the biological sample occurs at a temperature of less than −1° C. In some embodiments, automatically staining the biological sample occurs at a temperature of less than −2° C. In some embodiments, automatically staining the biological sample occurs at a temperature of less than −3° C. In some embodiments, automatically staining the biological sample occurs at substantially −2° C., −3° C., or a temperature there between. In some such embodiments, an automatic slide staining system as described elsewhere herein may be used to maintain the biological sample on a slide at such sub-freezing temperatures.

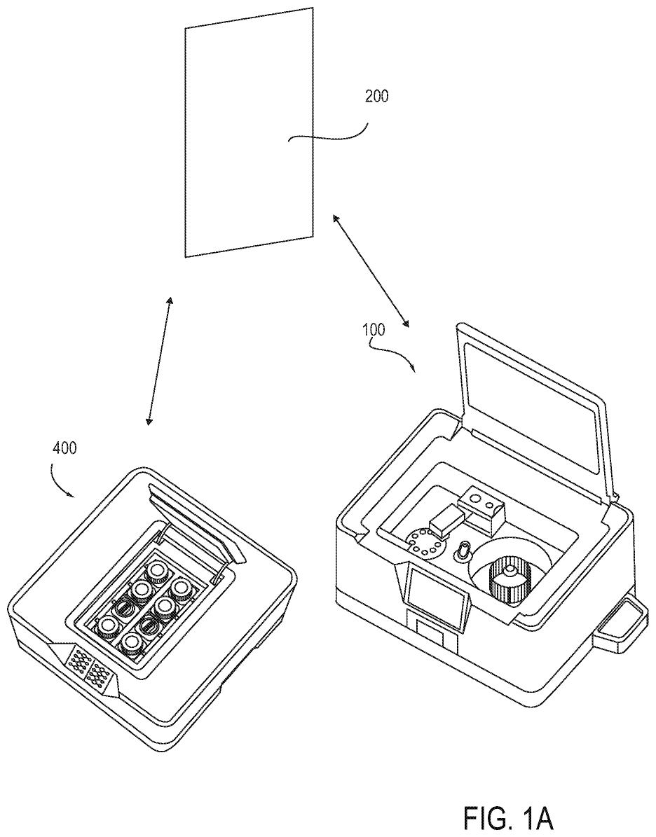

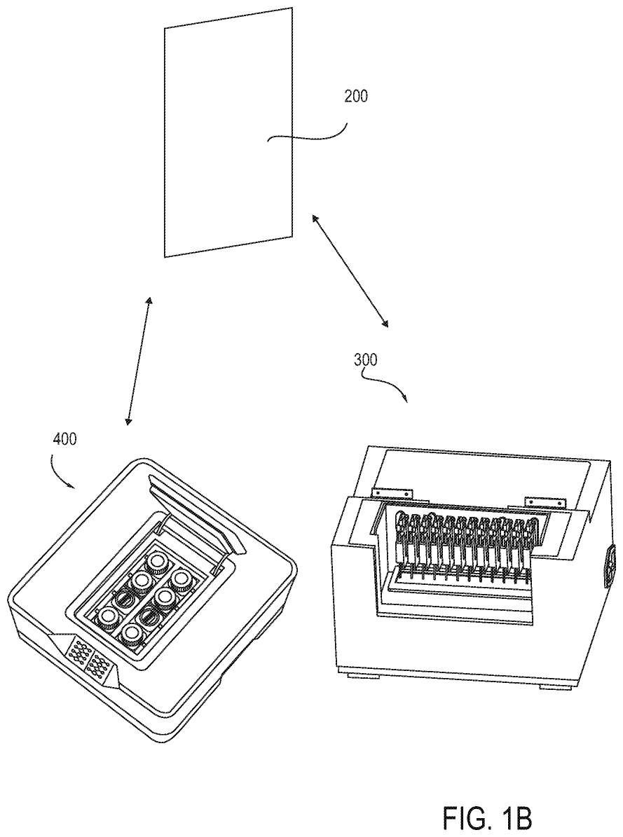

As shown in FIG. 1A, a slide 200 or biological sample attached to a slide 200 may be moved between a slide cooling apparatus 400 and an automatic slide staining system 100, both of which are described elsewhere herein, to complete a slide preparation protocol, for example to fix a biological sample to a slide 200 and then stain the biological sample adhered to the slide 200. In some embodiments, an automatic slide staining system 100 and a slide cooling apparatus 400 may be sold together as a kit; in other embodiments, an automatic slide staining system 100 and a slide cooling apparatus 400 may be sold separately or individually.

As shown in FIG. 1B, a slide 200 or biological sample attached to a slide 200 may be moved between a slide cooling apparatus 400 and a manual slide staining apparatus 300, both of which are described elsewhere herein, to complete a slide preparation protocol, for example to fix a biological sample to a slide 200 and then stain the biological sample adhered to the slide 200. In some embodiments, a manual slide staining apparatus 300 and a slide cooling apparatus 400 may be sold together as a kit; in other embodiments, a manual slide staining apparatus 300 and a slide cooling apparatus 400 may be sold separately or individually.

### Automatic Slide Staining System

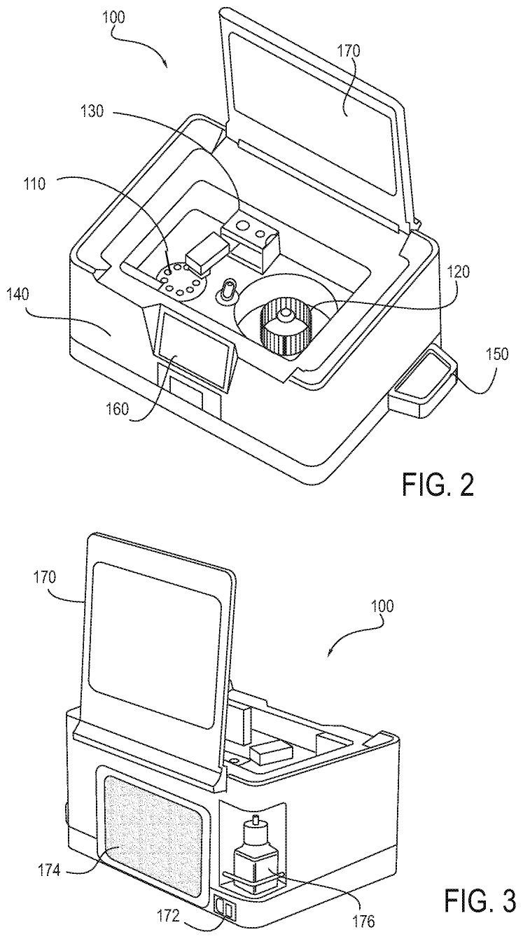

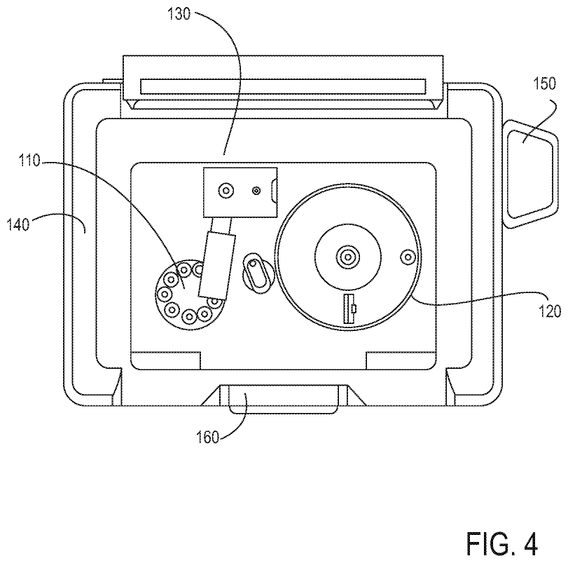

Described herein is a system 100 for automatically staining slides, as shown in FIGS. 2-5. The system 100 may include a slide management subsystem 120, a reagent management subsystem 110, and a fluid dispenser 130. In some embodiments, the system further includes a housing 140, an exterior drain tray 150, a display 160, a lid 170, a power switch 172, a vent 174, and a wash fluid tank 176. The system 100 functions to transfer reagent using the fluid dispenser 130 from the reagent management subsystem 110 to the slide management subsystem 120 and to maintain one or more reagents and one or more slides at a pre-determined temperature, as will be described in further detail elsewhere herein.

As shown in the FIGURES, a system 100 for automatically staining slides may include a housing 140. The housing 140 functions to insulate the reagent management subsystem 110 and slide management subsystem 120 from external temperature fluctuations or the ambient temperature. In such embodiments, the housing 140 may be formed of or include one or more insulating materials, for example fiberglass, foam (e.g., urea-formaldehyde, cementitious, and phenolic), polystyrene, polyisocyanurate, and polyurethane. The housing 140 may include one or more features 142 sized and/or shaped to receive one or more components of the system. A feature 142 may include an aperture, groove, cutout, divot, slot, or any other physical feature sized and/or shaped to receive one or more components of the system, for example the reagent management subsystem 110, the slide management subsystem 120, and/or the fluid dispenser 130. The housing may be manufactured from a mold, laser-cut, 3D printed, or otherwise structured to include the one or more features 142.

A system 100 for automatically staining slides may include an exterior drain tray 150. The exterior drain tray 150 functions to receive excess reagent or discarded fluid from one or more areas of the system, for example the slide management system 120, a purge tray 144, a fluid dispensing system 130, a wash fluid tank 176, or an evaporator 124. The exterior drain tray 150 includes a port 152 through which fluid flows into the exterior drain tray 150, a concave or recessed area 154 for collecting fluid, and a drain tray lid 156 for covering or sealing the exterior drain tray 150. Once the exterior drain tray 150 reaches capacity, it may be removed from the system, emptied, and reinserted for continued use.

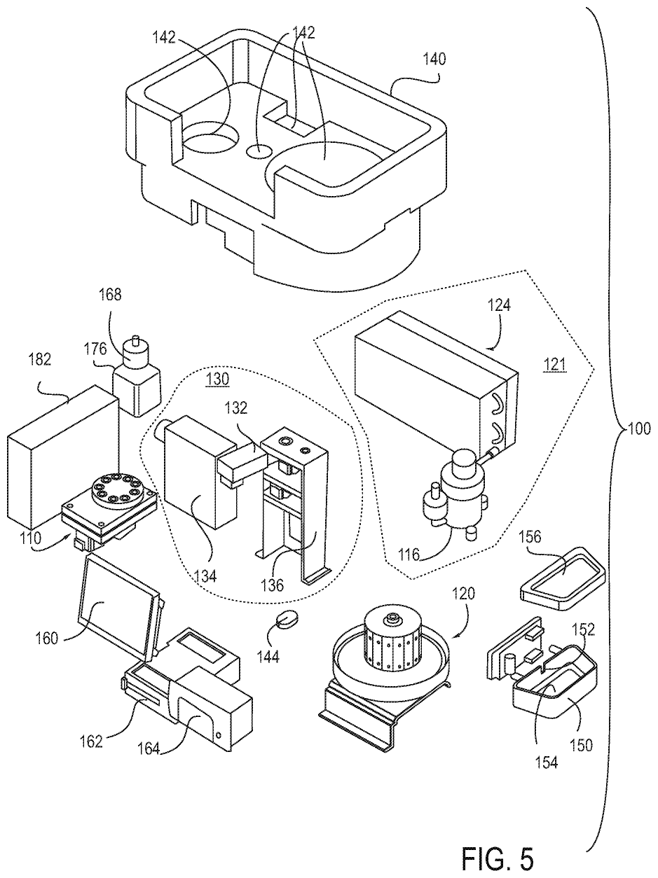

As shown in FIG. 5 in an exploded view 100, a system for automatically staining slides may include a wash fluid tank 176, as visible in FIGS. 3 and 5. The wash fluid tank 176 functions to house a fluid for use in purging the system, cleaning the system, washing the system, or otherwise flushing the system to prevent cross-contamination, remove debris, and/or clean the system before or after use. The fluid may flow from the wash fluid tank 176 to the fluid dispenser 130, out a nozzle 132 of the fluid dispenser 130 into the purge tray 144, and then into the exterior drain tray 150.

In some embodiments, to determine a height of a fluid in the wash fluid tank 176, a cap 168 of the wash fluid tank 176 may include a first probe and a second probe adjacent to each other, such that the two probes extend down to a bottom of the wash fluid tank 176. A electrical current flow is established in the first probe, and based on the electrolytic properties of a solution (e.g., phosphate buffered saline) in the wash fluid tank 176, the electrical current transverses through the solution to the second probe. If the fluid level drops below a tip of the first probe or the second probe, the electrical current between the first and second probes is interrupted which triggers an alarm indicating that more solution is required in the wash fluid tank 176.

Alternatively, in some embodiments, to determine a height of a fluid in the wash fluid tank 176, a cap 168 of the wash fluid tank 176 may include a rigid wire disposed in a probe, a float surrounding at least a portion of the probe, and a sensor (e.g., piezoceramic sensor) disposed in the cap 168. The float rests on a surface of a fluid in the wash fluid tank 176. The rigid wire comprises a magnetostrictive material, such that when the sensor emits one or more pulses of current through the wire, a circular magnetic field is generated. A level transmitter (e.g., magnet) in the float magnetizes the wire axially when the current is applied to the wire and generates one or more torsion waves that run along a length of the wire. One torsion wave runs directly up the probe to the sensor in the cap 168 and a second torsion wave is reflected from a bottom of wash fluid tank 176. To determine a fluid height in the wash fluid tank, a time between emission of the current pulse and an arrival of the torsion wave at the sensor is measured and then a position of the float (i.e., fluid height) is determined based on the transit times. In such embodiments, the torsion wave is detected and a position of the float is measured by a processor of the system, as described in further detail elsewhere herein.

As shown in FIG. 3 and FIG. 5, a system for automatically staining slides may include a power source 182 and a power switch 172. In some embodiments, the power source 182 functions to convert alternating current (AC) received from a wall outlet to direct current (DC) to power one or more components of the system. The power source 182 may include one or more transformers, a rectifier, one or more capacitors, and a regulator to step down, smooth, and convert the AC to DC for use by one or more components of the system. Alternatively or additionally, in some embodiments, the power source includes a battery (e.g., disposable or rechargeable) or a power inverter (i.e., to convert DC to AC). The power switch 172, for example a toggle switch, may be manipulated by a user of the system to turn on or off the system.

As shown in FIG. 5, a system for automatically staining slides may include a display 160, a printer 164, and a processor 162. The display 160 is as an output device configured to display settings, protocols, or other information to a user. In some embodiments, it is a touch-enabled display that also functions as a user input device. In other embodiments, other user input devices such as buttons, keys, knobs, or joysticks may be provided. The display 160 functions to enable a user of the system to select parameters of the staining protocol he/she desires to run using the system. For example, a user may input or select a number of slides positioned in a rotatable support of the slide management subsystem 120, positive and negative controls and their position in the rotatable support of the slide management subsystem 120, a cell staining protocol, and/or a number and/or position of reagents in a rotatable support of the reagent management system 110. A user may also select to print using the printer 164 a layout of the slides and/or reagents to ensure that all the slides and/or reagents are properly positioned in the system before the cell staining protocol is initiated.

A processor 162 may initiate one or more outputs based on the one or more inputs received from the user at the display 160. For example, the processor 162 may initiate a cell staining protocol, a print cycle, and/or one or more graphical user interfaces displayed to a user on the display 160 in response to a user selecting a set of parameters for a cell staining protocol. The processor 162 may be communicatively coupled to the fluid dispenser 130, reagent management subsystem 110, and slide management subsystem 120, for example to coordinate a movement timing between the fluid dispenser 130, reagent management subsystem 110, and slide management subsystem 120.

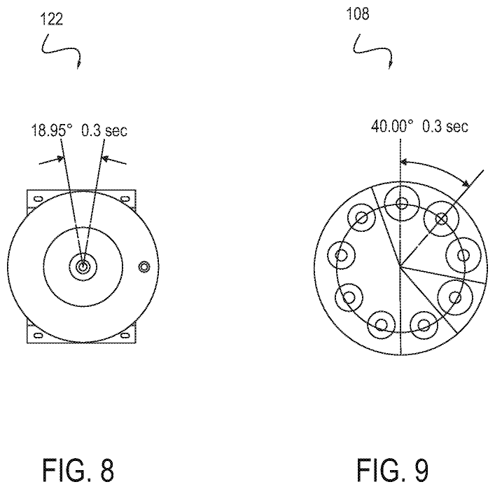

As mentioned above and shown in the FIGURES, a system 100 for automatically staining slides may include a slide management subsystem 120. The slide management subsystem 120 functions to receive one or more slides and to rotate the slides in response to a command received from a processor, such as the processor 162 or a processor present in the slide management subsystem 120 or elsewhere in the system 100. The slide management subsystem 120 includes a rotatable support 122 (also referred to herein as a slide rotatable support or a first rotatable support), a slide drain tray 123, a cooling unit 121 (formed at least in part of a compressor 116, evaporator 124, and cooling coil 126) (also referred to herein as a slide cooling unit or a first cooling unit), a motor unit 118, and a shaft 128. The motor unit 118 and the shaft 128 are configured to rotate the slide rotatable support 122 in response to a command received from the processor 162. As shown in FIG. 8, in some embodiments, the slide rotatable support 122 is configured to rotate between 16° and 20° in response to a command received from the processor 162. In one embodiment, the slide rotatable support 122 is configured to rotate between 18° and 19° in 0.1 to 1 second. In another embodiment, the slide rotatable support 122 is configured to rotate 18.95° in 0.3 seconds.

The slide management subsystem 120 may also include slide clip 180 and a slide holder 190, both of which will be described in further detail elsewhere herein.

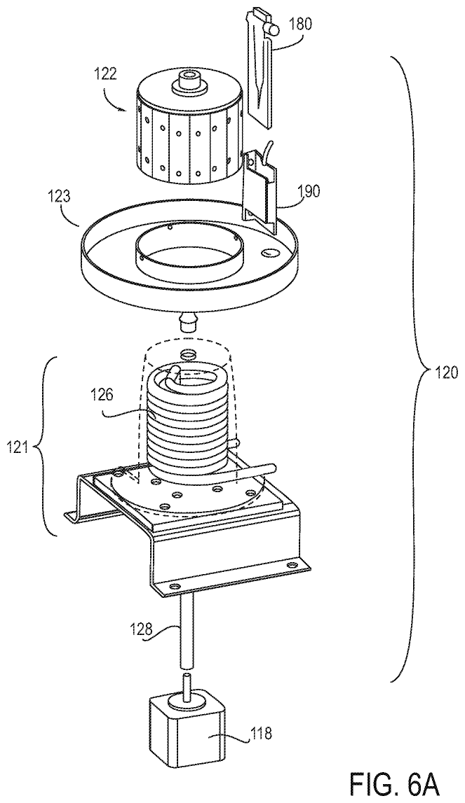

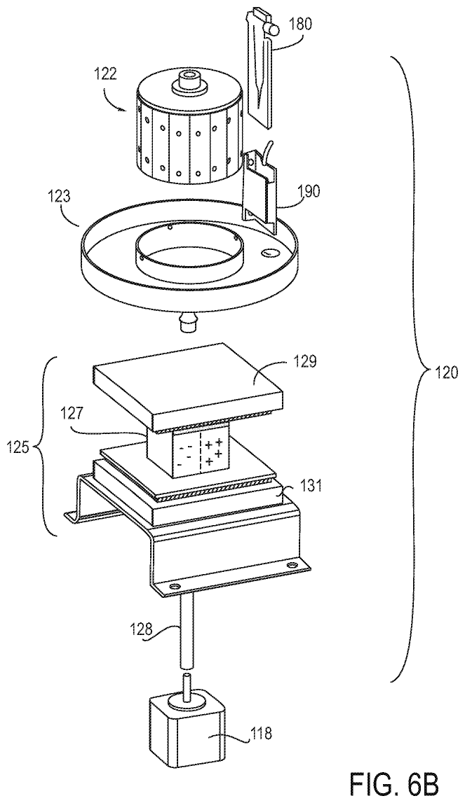

As shown in FIG. 6A, a slide management subsystem 120 may include a slide rotatable support 122. The slide rotatable support 122 may include one or more slots configured to receive a slide holder 190 or a slide clip 180. In some embodiments, the slide holder 190 or slide clip 180 may be matingly received in a slot on a surface of the slide rotatable support 122, screwed or bolted into a surface of the slide rotatable support 122, magnetically coupled to a surface of the slide rotatable support 122, or otherwise coupled to the slide rotatable support 122. In some embodiments, the slide rotatable support 122 includes a sensor at each slide position to detect a temperature of a slide coupled to the slide rotatable support 122; in other embodiments, one or more sensors positioned on the slide rotatable support 122 are used to determine a temperature of a slide coupled to the slide rotatable support 122 based on a detected temperature of the slide rotatable support 122. The slide rotatable support 122 may be configured to receive one to five slides, one to ten slides, one to twenty slides, or one to thirty slides. In one embodiment, the slide rotatable support is configured to receive eighteen slides. In some embodiments, the slide rotatable support 122 may be configured as a carousel, a cylinder, or otherwise substantially circular or round member. Alternatively, in some embodiments, the slide rotatable support 112 may be configured as a hexagon, octagon, decagon, dodecagon, or other shape having a plurality of sides such that the slides, when rotated on the rotatable support, substantially follow a circumferential path. In various embodiments, the slide holder 190 or the slide clip 180 is oriented on the slide rotatable support 122 such that a longitudinal axis of each received slide is substantially perpendicular to a surface of the slide rotatable support 122. The slide rotatable support 122 may comprise a material having cold (e.g., freezing or sub-freezing temperature) conducting and/or retaining properties, for example aluminum, metal, iron, steel, copper, and porcelain, such that slide rotatable support 122 becomes cold and stays cold so that one or more slides coupled to the slide rotatable support 122 are also cold.

The slide rotatable support 122 may be positioned over a slide drain tray 123, which functions to receive excess fluid that is applied to one or more slides positioned in the slide holder 190 or slide clip 180. The fluid received in the slide drain tray 123 flows from the slide drain tray 123 to the exterior drain tray 150. The slide drain tray 123 may have any size and/or shape necessary to be positioned beneath the slide rotatable support 122. In some embodiments, the slide drain tray 123 has a toroidal shape.

As shown in FIG. 6A, a slide management subsystem 120 may further include a slide cooling unit 121. The slide cooling 121 unit functions to reduce a temperature of the slide management subsystem 120. In some embodiments, the slide cooling unit 121 functions to cool the slide rotatable support 122 to between −20° C. and 0° C., −10° C. and 0° C., −5° C. and 0° C., −3° C. and 0° C., or −3° C. and −1° C. The slide cooling unit 121 may include a thermoelectric cooler, a compressor, or any other cooling apparatus known to one of skill in the relevant art.

As shown in FIGS. 5-6A, a slide cooling unit 121 may include one or more compressors 116 and one or more evaporators 124 each including condenser coils (within evaporators 124) and cooling coils 126. Refrigerant moves from the compressor 116 to the condenser coils to the cooling coils 126 in a repetitious cycle. The compressor 116 compresses the refrigerant, received from the evaporator 124, into high pressure (i.e., high temperature) refrigerant gas. The heated refrigerant gas then flows to the condenser coils, which condenses the refrigerant gas into a hot liquid refrigerant using, for example, ambient air and one or more fans. The liquid refrigerant exits the condenser coils and flows to a metering device (e.g., expansion valve or capillary tube). The metering device creates a pressure drop resulting in a cooled refrigerant liquid-gas mixture. The cooled refrigerant flows into the cooling coils 126 of the evaporator 124 and vaporizes as it absorbs heat from the slide rotatable support 122. The refrigerant then exits the cooling coil 126 as a gas, enters the compressor 116, mixes with liquid refrigerant, and the cycle repeats.

Alternatively, as shown in FIG. 6B, the slide cooling unit may comprise one or more thermoelectric coolers 125, for example each using the Peltier effect. Two unique semiconductors 127 are placed thermally in parallel to each other and electrically in series and joined to a first thermally conducting plate 129 (also referred to herein as a cooling plate) and second thermally conducting plate 131 (also referred to herein as a heating plate), the first plate 129 opposite the second plate 131. When a voltage is applied to the free ends of the two semiconductors 127, there is a flow of DC current across the junction of the semiconductors 127 resulting in a temperature difference. The cooling plate 129 absorbs heat which is then moved to the heating plate 131, which functions as a heat sink. In some embodiments, the heating plate 131 is cooled by a water cooling block, as described elsewhere herein. The effectiveness of the thermoelectric cooler 125 may be dependent on an ambient temperature in which the system resides. For example, a thermoelectric cooler 125 may be able to reach a temperature equal to ambient temperature minus 40° C. Therefore, in some embodiments, multiple thermoelectric coolers may be required to reach temperatures equal to ambient temperature minus a value greater than 40° C.

In some embodiments, a thermoelectric cooler 125 may use pulse width modulation to control a temperature of the slide rotatable support 122. In such embodiments, power provided to the thermoelectric cooler 125 is switched quickly “ON” and “OFF” at a constant frequency. This creates a square wave “pulse” of power with a constant time period. The “ON” time, or pulse width, can be varied to create an average output voltage (Vaverage) that is required by the thermoelectric cooler 125 to maintain a pre-determined temperature. A minimum voltage required by the thermoelectric cooler 125 may range from 1 V of DC (VDC) up to 100 VDC. In one embodiment, Vaverage required by the thermoelectric cooler 125 is between 10 VDC and 15 VDC. In one embodiment, Vavera_{g}e required by the thermoelectric cooler 125 is 12 VDC.

In some embodiments, one slide cooling unit may be used to cool the entire slide rotatable support 120; in other embodiments, each slide coupled to the slide rotatable support 120 may have its own slide cooling unit, such that a number of slide cooling units matches a maximum number of slides that can be coupled to the slide rotatable support 120.

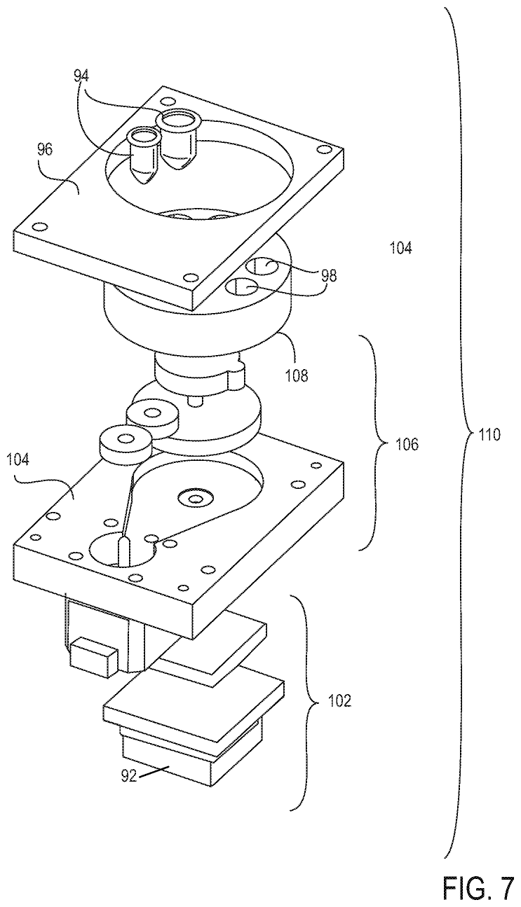

As shown in FIG. 5 and FIG. 7, a reagent management subsystem 110 may include a rotatable support 108 (also referred to herein as a reagent rotatable support or a second rotatable support), a motor unit 106, a cooling block 104, and a cooling unit 102 (also referred to herein as a reagent cooling unit or a second cooling unit). The reagent management subsystem 110 functions to house one or more receptacles 94 (e.g., one or more containers or vials) holding reagent and maintain the one or more receptacles 94 at a pre-determined temperature. As shown in FIG. 7, the reagent rotatable support 108 includes one or more pockets 98 sized and/or shaped for receiving a receptacle 94 therein. The reagent rotatable support 108 may be rotated by the motor unit 106 (e.g., a stepper motor) comprising a series of gears and plates, such that the receptacle 94 substantially follows a circumferential path when the reagent rotatable support is rotated. The reagent rotatable support 108 may be configured as a carousel, a cylinder, or otherwise substantially circular or round member. Alternatively, in some embodiments, the reagent rotatable support 108 may be configured as a hexagon, octagon, decagon, dodecagon, or other shape having a plurality of sides. As shown in FIG. 9, in some embodiments, the reagent rotatable support 144 is configured to rotate between 30° and 45° in response to a command received from the processor 162. In one embodiment, the reagent rotatable support 108 is configured to rotate between 35° and 45° in 0.1 to 1 second. In another embodiment, the reagent rotatable support 108 is configured to rotate 40° in 0.3 seconds.

The reagent management subsystem 110 may further include a reagent cooling unit 102 and a cooling block 104. The reagent cooling unit 102 may include a thermoelectric cooler or a compressor. The thermoelectric cooler or compressor of the reagent cooling unit 102 may be structured so as to be similar or identical to any of the thermoelectric coolers or compressors described elsewhere herein. In some embodiments in which the reagent cooling unit 102 is a thermoelectric cooler, the reagent cooling unit 102 may further include one or more fans 92 to dissipate heat from a heat sink of the reagent cooling unit 102. The cooling effect produced by the reagent cooling unit 102 may be transmitted to the reagent rotatable support 108 via the cooling block 104. In some embodiments, the reagent cooling unit 102 is configured to maintain the reagent rotatable support 110 between −2° C. and 4° C., −5° C. and 10° C., −2° C. and 15° C., and −2° C. and 20° C. In some embodiments, the reagent cooling unit 102 is configured to maintain the reagent rotatable support 108 between −2° C. and 6° C. or 0° C. and 6° C.

The cooling block 104 may include one or more cutouts, impressions, or grooves configured to receive one or more gears of the motor unit 106. The reagent management subsystem 110 of some embodiments may further include a cover plate 96 to conceal the motor unit 106 and the cooling block 104.

One or more of the reagent rotatable support 108 and the cooling block 104 may include, or be formed of, a material having cold (e.g., freezing or sub-freezing temperature) conducting and/or retaining properties, for example aluminum, metal, iron, steel, copper, and porcelain, such that reagent rotatable support 108 and/or cooling block 104 becomes cold and stays cold so that one or more receptacles deposited in the reagent rotatable support 108 are also cold.

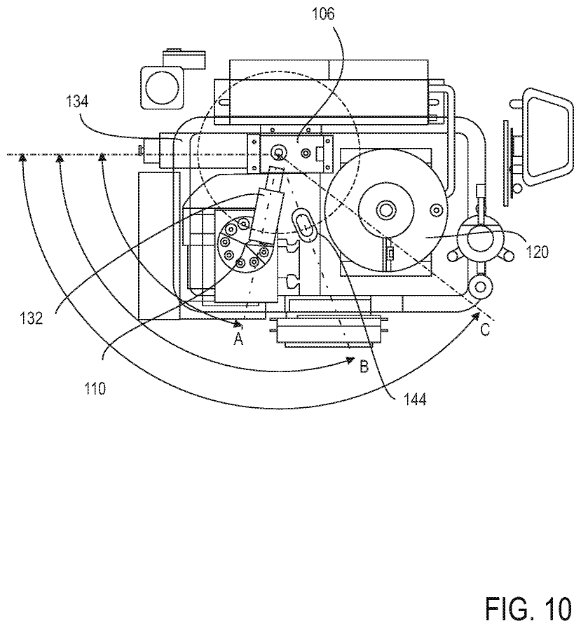

Returning to FIG. 5, a system for automatically staining slides may comprise a fluid dispenser 130 that includes a motor unit 136, a nozzle 132, and a fluid dispenser controller 134. The fluid dispenser 130 functions to move reagent from the reagent management subsystem 110 to the slide management subsystem 120 and to purge the system in between protocol steps by purging the system with a fluid from the wash fluid tank 176 that passes through the nozzle 132 into a purge tray 144. The motor unit 136 may be formed of or include a brush-commutated motor, a brushless DC electric motor (e.g., a stepper motor), a slotted brushless motor, or a slotless brushless motor. The motor unit 136 functions to move the nozzle 132 vertically (i.e., Z-axis) to draw up reagent from a receptacle in the reagent management subsystem 110 and horizontally (i.e., X-axis) to deposit the reagent on a slide in the slide management subsystem 120. As shown in FIG. 10, if the position of the fluid dispenser controller 134 in an X-axis plane is considered 0°, then the nozzle 132 is configured to move between three positions based on instructions received from processor 162: substantially 78° at a first position A (i.e., the reagent management subsystem 110), substantially 110° at a second position B (i.e., purge tray 144), and substantially 142.5° at a third position C (i.e., slide management subsystem 120). Although specific positions are indicated, it is to be appreciated by one of skill in the art that the relative positions of the nozzle 132 may vary depending on a size of the system, a size or position of the reagent management subsystem 110, a size or position of the slide management subsystem 120, and/or a size or position of the purge tray 144. In some embodiments, the nozzle 132 moves between a first position A and second position B or a second position B and a third position C in between 0.1 second and 3 seconds. In one embodiment, the nozzle 132 moves between a first position A and second position B or a second position B and a third position C in 0.5 seconds.

The nozzle 132 may include a metal rod for controlling a vertical movement (i.e., Z-axis movement) of the nozzle 132. For example, when nozzle 132 vertically moves into the reagent in the receptacle and current flows through the rod, the current is detected by the fluid dispenser controller 134. When current is detected, the fluid dispenser controller 134 initiates fluid uptake, for example from a receptacle disposed in a reagent rotatable support 108, or release from the nozzle 132, for example to a slide in the slide rotatable support 122 or into a purge tray 144. In some embodiments, the fluid dispenser controller 134 further controls a valve that regulates uptake of one of: a reagent from the reagent rotatable support 108 and a fluid, for example wash fluid, from a wash fluid tank 176.

In some embodiments, when no current is detected, processor 162 executes instructions to terminate a vertical movement (Z-axis movement) of the motor unit 136 so that the nozzle 132 does not progress further (i.e., too deep) into the reagent. Conversely, when current is detected, processor 162 executes instructions to initiate a vertical movement of the motor unit 136 so that nozzle 132 enters a reagent in a receptacle 94. The processor 162 controls current flow to the metal rod in the nozzle 132, motor unit 136 activation and cessation, and X-axis movement of the nozzle 132 between two or more positions, for example, reagent management subsystem 110, purge tray 144, and slide management subsystem 120.

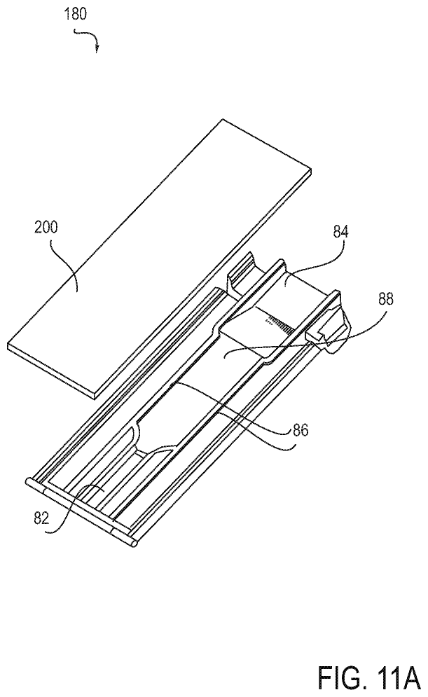

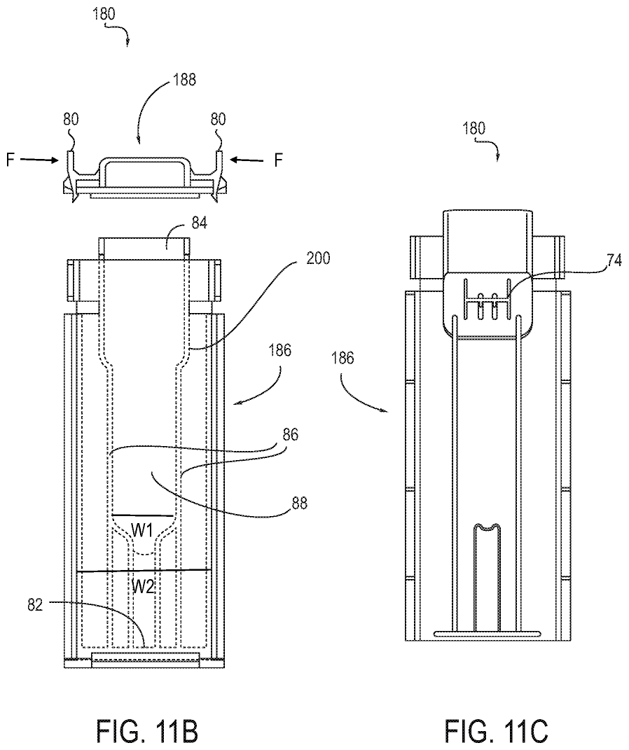

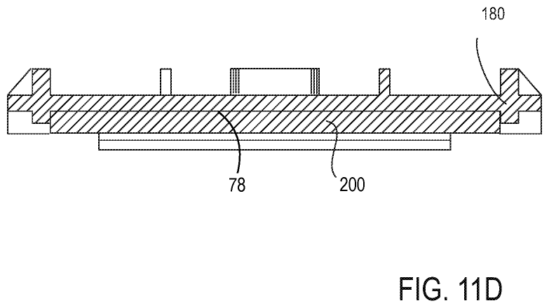

Turning to FIGS. 11A-11D, in some embodiments, a system for automatically staining slides includes a slide clip 180. The slide clip 180 couples to a slide 200 and functions to create a capillary gap 78 on a surface of the slide 200. Additionally, in some embodiments, the slide clip 180 functions to couple the slide 200 to the slide rotatable support 122. The slide clip 180 may include a clip body 186 and a clip head 188. In some embodiments, the clip body 186 and clip head 188 are formed as one component, for example via injection molding; in other embodiments, the clip body 186 and clip head 188 are separate components. The clip body 186 includes a recessed section 88 defined by a plurality of sidewalls 86. A space between a surface of the slide 200 and the recessed section 88, defined by the plurality of sidewalls 86, is referred to herein as a capillary gap 78. Fluid may be deposited into the capillary gap 78 via inflow track 84 and excess fluid may exit the capillary gap 78 via outflow track 82. The clip head 188 functions to secure the slide clip 180 to the slide 200 using handles 80. The handles 80 may be manipulated by applying force F to the handles, for example squeezing or pinching, to secure or remove the slide clip 180 from the slide 200. In some embodiments, the clip head 188 further forms inflow track 84 so that a nozzle 132 of the system can easily apply reagent into the capillary gap 78.

As shown in FIG. 11D, which depicts a cross-section of FIG. 11B, the capillary gap 78 created between a surface of the slide 200 and the recessed section 88 of the slide clip 180 may be between 50 and 200 micrometers. In another embodiment, the capillary gap 78 is between 80-120 micrometers. In still another embodiment, the capillary gap 78 is substantially 100 micrometers. In some embodiments, as shown in FIG. 11B, a width W₁ of the capillary gap 78 may be adjusted to match or fit on a perimeter of a width of a cell sample spun onto the slide 200 or a tissue section adhered to the slide 200. For example, the plurality of sidewalls 86 defining the recessed section 88 may be adjusted inward or outward (e.g., by sliding) to accommodate a smaller or larger, respectively, cell sample or tissue section. The ability to adjust the capillary gap 78 to a size of the cell sample or tissue section on the slide 200 saves over 50% reagent compared to other currently available systems that have no outflow track 82 and a capillary gap 78 that spans an entire length and width W₂ of the slide 200. In some embodiments, a width W₁ of the capillary gap 78 equals a width W₂ of the slide. Alternatively, in some embodiments, a width W₁ of the capillary gap 78 is less than a width W₂ of the slide. For example, W₁ may be 5%, 10%, 15%, 20%, 25%, 30%, 35%, 40%, 45%, 50%, 55%, 60%, 65%, 70%, 75%, 80%, 85%, 90%, 95%, or 100% of W₂. The slide clip 180 may be formed of a plastic, for example polypropylene, polyethylene terephthalate, high-density polyethylene, polyvinyl chloride, low-density polyethylene, polystyrene, polycarbonate, polylactide, or polyacrylate.

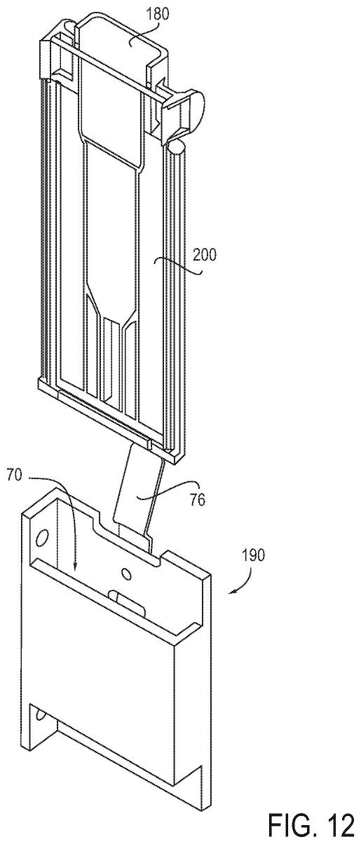

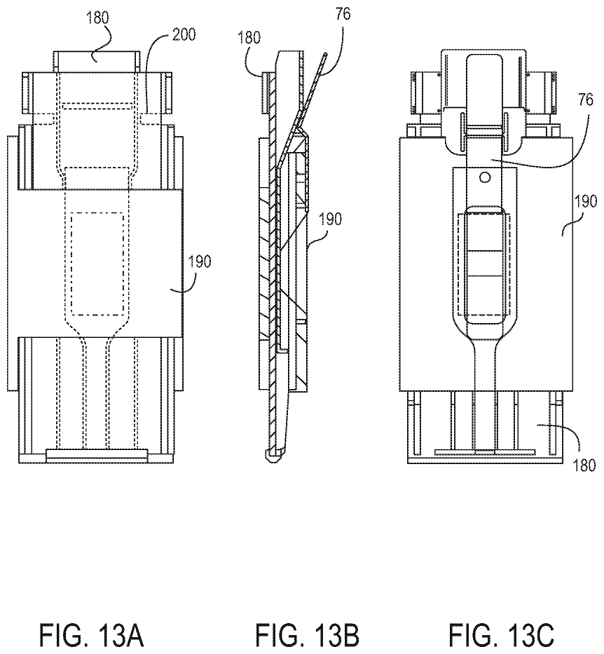

Turning to FIGS. 11C, and 12-13C, in some embodiments, a system for automatically staining slides includes a slide holder 190. The slide holder 190 functions to receive a slide clip 180 coupled to a slide 200 and couple the slide clip 180 and slide 200 to a slide rotatable support 122. Alternatively, in some embodiments, the slide holder 190 functions to receive a slide 200 and couple the slide 200 to a slide rotatable support 122. As shown in FIG. 12, the slide holder 190 comprises a slot 70 sized and shaped to receive the slide clip 180. The slide clip 180 is secured in the slide holder 190 via a lever 76 and a catch 74. The slide holder 190 may include, or be formed of, a material having cold (e.g., freezing or sub-freezing temperature) conducting and/or retaining properties, for example aluminum, metal, iron, steel, copper, or porcelain, such that slide holder 190 becomes cold and stays cold so that a slide held in the slide holder 190 is also cold.

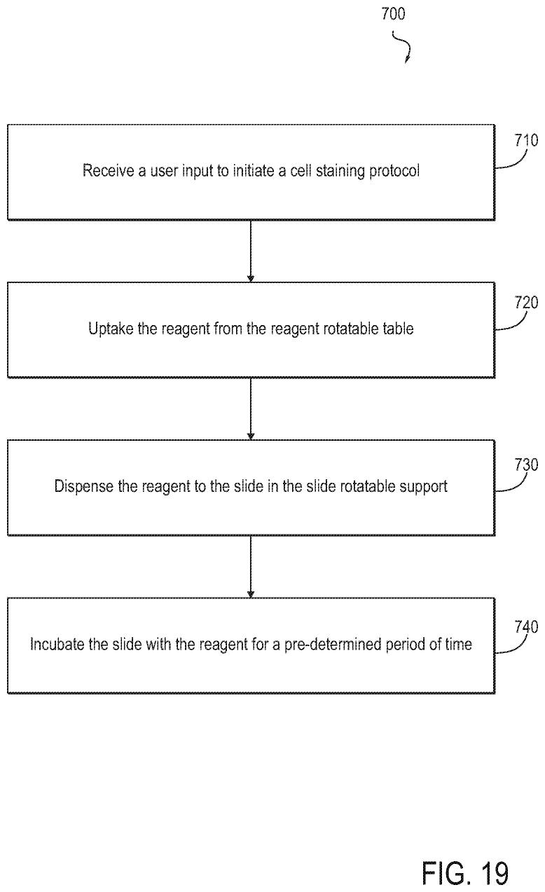

In some embodiments, as shown in FIG. 19, a method 700 for automatically staining slides includes: receiving a user input to initiate a cell staining protocol 710, uptaking the reagent from the reagent rotatable support 720, dispensing the reagent to a slide in the slide rotatable support 730, and incubating the slide with the reagent for a pre-determined period of time 740. The method 700 is performed to automatically stain cells or tissue attached to a slide while maintaining the reagents and slides at a suitable temperature. In some embodiments, method 700 is executed by a single processor or one or more processors. In some embodiments, one or more steps are repeated, for example to add multiple stains, antibodies, or buffers to the slide.

The method 700 may include pivoting, adjusting, or otherwise moving a fluid dispenser from the reagent rotatable support to the slide rotatable support. The method 700 may include rinsing the fluid dispenser with a fluid and purging the fluid from the fluid dispenser into a purge tray.

The method 700 may include rotating the slide rotatable support to align a second slide with the fluid dispenser. Alternatively or additionally, the method 700 may include rotating the reagent rotatable support to align a second reagent with the fluid dispenser.

### Manual Slide Staining Device

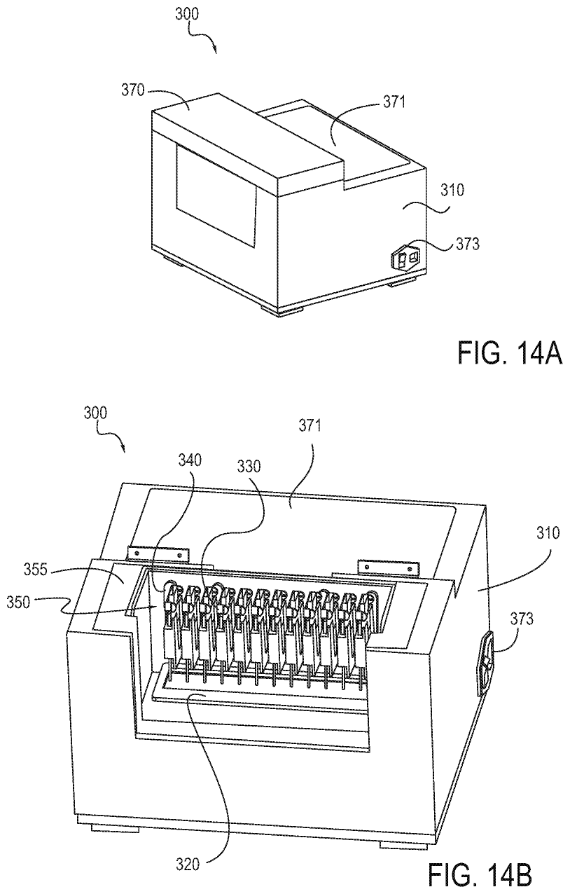

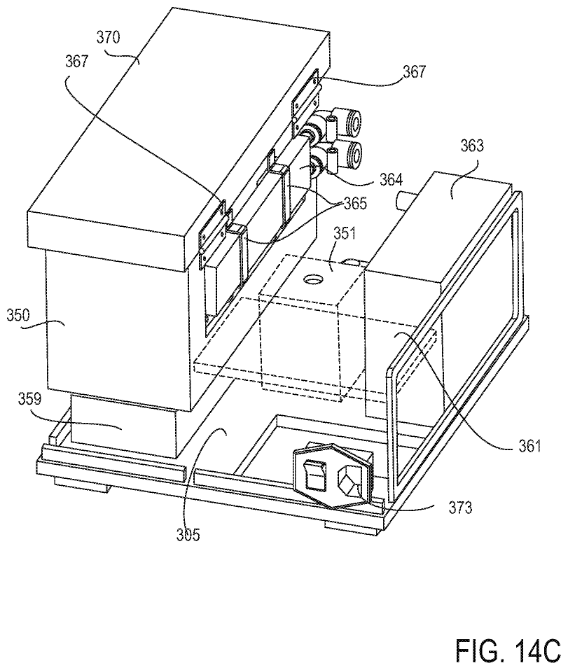

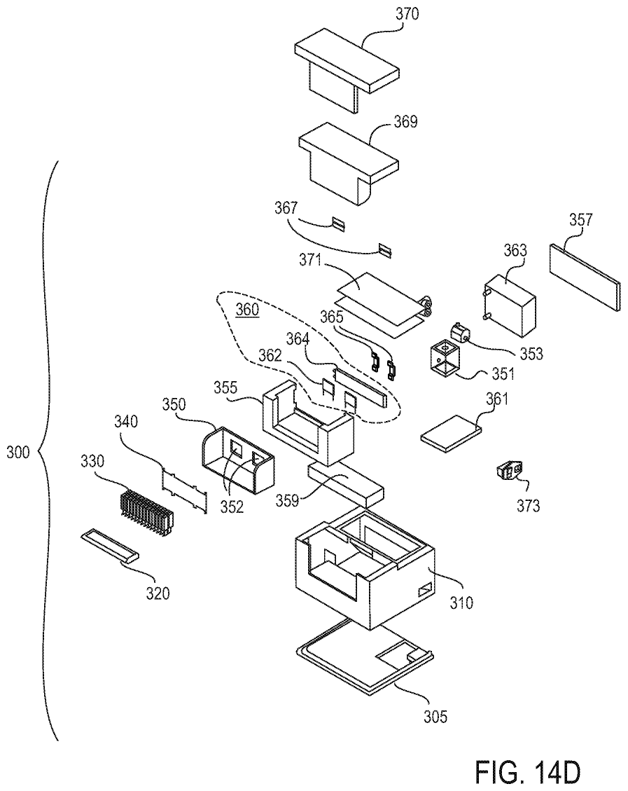

Turning to FIGS. 14A-14D, in some embodiments, a manual slide staining device 300 may be used. In some embodiments, the manual slide staining device 300 functions to cool one or more slides to between −20° C. and 0° C., −10° C. and 0° C., −5° C. and 0° C., −3° C. and 0° C., or −3° C. and −1° C. A manual slide staining device 300 may be used in place of an automatic slide staining system 100 or in conjunction with an automatic slide staining system 100. A manual slide staining device 300 may include a base 305, housing 310, a drip tray 320, a slide receptacle 330, an attachment plate 340, a support 355, a cooling plate 350, a cooling unit 360, a front access lid 370, a rear access lid 371, and a switch 373. The rear access lid 371 and front access lid 370 are coupled to the housing 310 via one or more hinges 367. The housing 310, rear access lid 371, front access lid 370, and front access lid insulation 369 may be formed of, or include, one or more insulating materials, for example, fiberglass, foam (e.g., urea-formaldehyde, cementitious, and phenolic), polystyrene, polyisocyanurate, and polyurethane. One or more components of the device 300 may be shielded from the ambient temperature via front access lid 370 and front access lid insulation 369. The housing 310 is coupled to base 305 and is sized and shaped to receive in a stacked or layered configuration a support 355, cooling plate 350, drip tray 320, and a slide receptacle 330 coupled to an attachment plate 340. One or more slides in the slide receptacle 330 are cooled by a cooling unit 360 attached to the cooling plate 350 using brackets 365. The cooling plate 350 is positioned in the housing 310 and provides a support for a drip tray 320, a slide receptacle 330, an attachment plate 340, and a cooling unit 360. The slide receptacle 330 is positionable on top of the drip tray 320, which is placed within the cooling plate 350, so that excess fluid from one or more slides deposited in the slide receptacle 330 is collected in the drip tray 320 and later discarded. The slide receptacle 330 includes a plurality of slots, each sized and shaped to receive a slide therein. The slide receptacle 330 is coupled to the attachment plate 340 to secure the slide receptacle 330 to the cooling plate 350. One or more cutouts 352 in the cooling plate 350 are sized and shaped to receive one or more thermoelectric coolers 362. A water cooling block 364 is secured to the one or more thermoelectric coolers 362 and the cooling plate 350 via one or more brackets 365.

The water cooling block 364 may be in fluid communication with a reservoir 351, water pump 353, and a radiator 363. The heat stored in the one or more thermoelectric coolers 362, as described elsewhere herein, is transferred to water flowing through the water cooling block 364. The water is pumped to the reservoir 351 using a water pump 353. The water then flows to the radiator 363 where the water is cooled by a fan mounted on said radiator 363, thus resulting in the heat stored in the one or more thermoelectric coolers 362 being dissipated, for example through vent 357.

The device 300 as shown in FIGS. 14A-14D may further include a processor 361 and a power source 359. One or more cooling cycles may be controlled by a processor 361, as shown in FIGS. 14C-14D. The device 300 may further include a power source 359, similar to power source 182 described in FIG. 5.

### Automatic Slide Cooling Apparatus

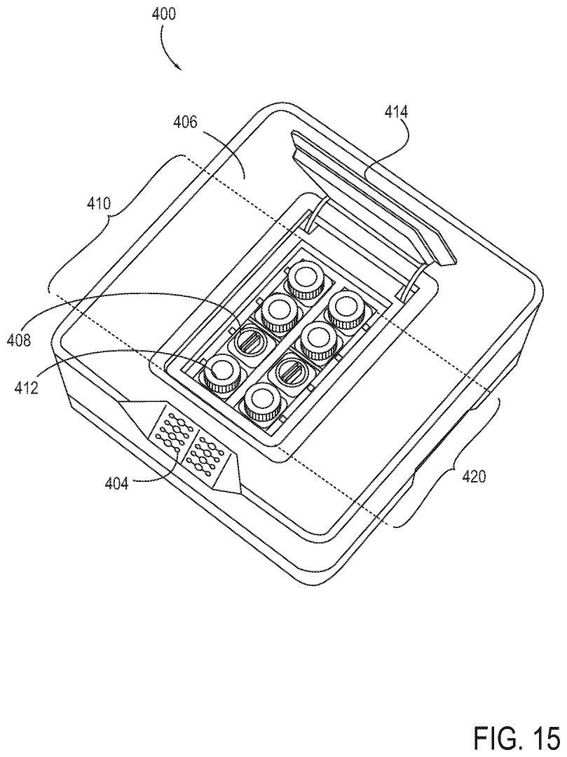

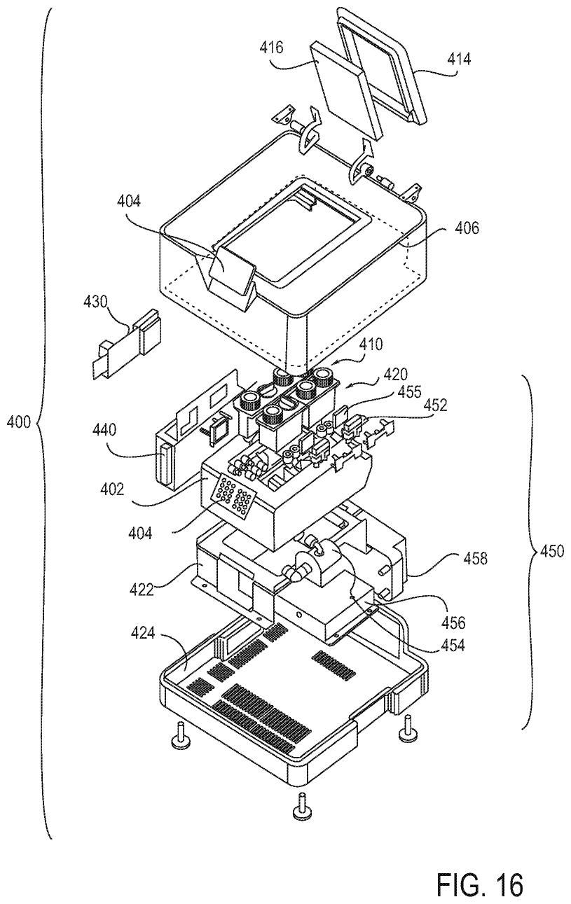

Turning now to FIGS. 15-16, an automatic slide cooling apparatus 400 is shown. An automatic slide cooling apparatus 400 functions to maintain one or more slides at a fixed temperature for a pre-determined period of time, and in some embodiments, alert a user to a temperature fluctuation or a termination of the pre-determined period of time. An automatic slide cooling apparatus 400 may include a first cooling platform 410 and a second cooling platform 420. In some embodiments, the first cooling platform 410 is at the same temperature as the second cooling platform 420; in other embodiments, the first cooling platform 410 is at a different temperature than the second cooling platform 420. The first cooling platform 410 and second cooling platform 420 each include one or more apertures 408 that are sized and/or shaped to receive a container 412. The container 412 may house one or more slides therein, for example in a fixative, stain, wash buffer, or any other type of fluid. The automatic slide cooling apparatus 400 may further include an exterior housing 406 and an interior housing 402 configured to receive one or more components therein, as will be described in further detail elsewhere herein. The automatic slide cooling apparatus 400 may also include a display 404, as will be described in further detail elsewhere herein.

As shown in the exploded view of FIG. 16, an automatic slide cooling apparatus 400 includes a first cooling platform 410 and a second cooling platform 420. Each cooling platform 410, 420 includes one or more cooling elements 455, for example one or more thermoelectric coolers or one or more compressors, to decrease a temperature of the cooling platform 410, 420 to a pre-determined temperature or temperature range. For example, a first cooling element 455 may decrease a temperature of a first cooling platform to between 4° C. and −20° C., 0° C. and −10° C., 0° C. and −5° C., 1° C. and −3° C., or 0° C. and −3.5° C. Further for example, a second cooling element 455 may decrease a temperature of a second cooling platform to between −5° C. and −50° C., −10° C. and −50° C., −10° C. and −40° C., −15° C. and −35° C., −20° C. and −25° C., or −22° C. and −28° C. An automatic slide cooling apparatus 400 may further include a central cooling unit (CCU) 450, which includes a water cooling block 452, a water pump 454, a reservoir 456, and a radiator 458 with mounted fan. The CCU 450 functions to pump fluid (e.g., water) from the reservoir 456 through a series of channels in the water cooling block 452, which is coupled to the one or more cooling elements 455. The fluid absorbs heat from the one or more cooling elements 455, for example a heat sink associated with a thermoelectric cooler, and the water pump 454 pumps the heated fluid to the reservoir 456. The water then flows onward into the radiator 458, where the fluid is cooled by one or more fans mounted on said radiator 458. In some embodiments, the one or more cooling elements 455 may be positioned between the first and second cooling platforms 410, 420 and the cooling block 452, for example using one or more brackets or coupling elements to secure the one or more cooling elements 455 to the first and second cooling platforms 410, 420.

An automatic slide cooling apparatus 400 may further include an exterior housing 406, an interior housing 402, and a lid 414 including an insulating layer 416. The interior housing 402 and lid 414 function to insulate the cooling platforms 410, 420 from ambient air and from heat produced by other components within the exterior housing 406. The interior housing 402 and insulating layer 416 may be formed of or include one or more insulating materials, for example, fiberglass, foam (e.g., urea-formaldehyde, cementitious, and phenolic), polystyrene, polyisocyanurate, and polyurethane. The exterior housing 406 functions as an encasement or cover for one or more components of the apparatus, such that the one or more components, for example cooling platforms 410, 420, may remain accessible through one or more apertures in the exterior housing 406. The exterior housing 406 may be formed of or include: a plastic, for example, polypropylene, polyethylene terephthalate, high-density polyethylene, polyvinyl chloride, low-density polyethylene, polystyrene, polycarbonate, or polylactide; or sheet metal. The lid 414 may be coupled to the exterior housing 406 using a hinge, for example, including torque damping to prevent unexpected or rapid closing of the lid 414.

As shown in FIG. 16, an automatic slide cooling apparatus 400 may include an adaptor 422 and a base 424. The adaptor 422 and base 424 function to physically stabilize one or more components of the apparatus, for example, the one or more components may be secured to the adaptor 422 or base 424. The base 424 also functions as an interface between the one or more components and a surface on which the apparatus rests, for example, a table top or work bench.

As shown in FIG. 16, an automatic slide cooling apparatus 400 may include a power supply 440, similar to power source 182 and 359 described in FIG. 5 and FIGS. 14A-D, respectively; a processor 430; and a display 404. The processor 430 functions to receive one or more user inputs on a display 404, execute instructions based on the one or more user inputs, execute instructions from one or more programs or applications stored in memory, execute instructions to alert a user of a malfunction of the system or user error, and/or control a temperature or temperature range of cooling platforms 410, 420.

The display 404 includes one or more optical indicators and one or more user input elements, for example buttons, toggle switches, etc., the function of which is described in more detail elsewhere herein.

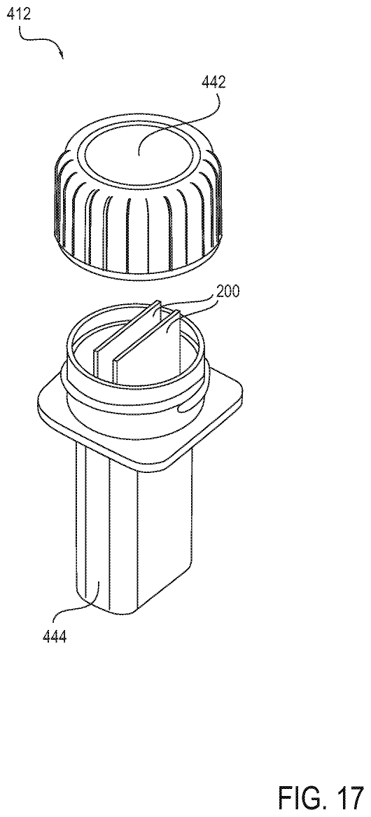

In some embodiments, as shown in FIG. 15 and FIG. 17, an automatic slide cooling apparatus 400 may further include a container 412 comprising a container body 444 and a container cap 442. The container 412 is sized and shaped to receive one or more slides 200 therein and a fluid, for example a fixative therein. A perimeter surface of an aperture 408 and a perimeter surface of a container 412 may have complementary edges, grooves, or textures so that the container 412 is matingly received in the aperture 408. The aperture 408 may further include one or more sensors for detecting a presence of the container 412 in the aperture 408. In some embodiments, the container 412 includes one or more sensors for detecting a presence of one or more slides 200 in the container 412. Non-limiting examples of sensors include: optical (e.g., laser), motion, mechanical (e.g., switch), or any other type of sensor.

The container cap 442 may be reversibly coupled to the container body 444, for example via threads, snap-fit connection, hinge, or any other mechanism. In some embodiments, when the container cap 442 is coupled to the container body 444, the container 412 is one or more of leak proof, water proof, or sealed. In one embodiment, the container is hermetically sealed.

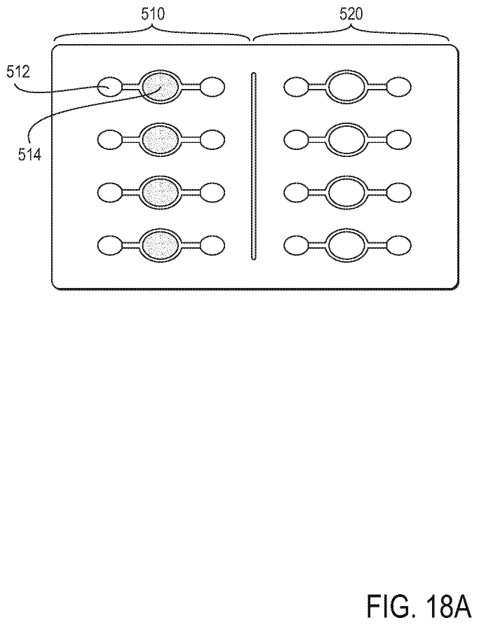

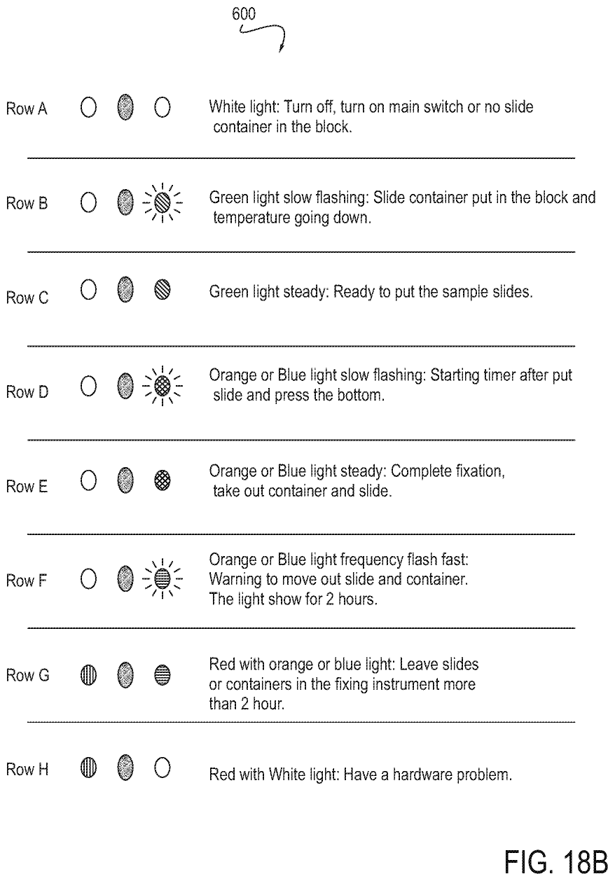

FIG. 18A shows one embodiment of a display 404 of an automatic slide cooling apparatus 400. The display 404 functions to show a status of one or more containers 412 and/or the first cooling platform 410 and second cooling platform 420. The display 404 may include a first panel 510 for displaying a status of the first cooling platform 410 and a second panel 520 for displaying a status of the second cooling platform 420. Each panel 510, 520 may include an optical indicator 512 and a user input element 514 per container 412. In some embodiments, the first panel 510 may use a first color or range of colors to indicate a status of the first cooling platform 410 and the second panel 520 may use a second color or range or colors to indicate a status of the second cooling platform 420.

The user input element 514 may function to activate a temperature change sequence for a corresponding aperture 408 in a corresponding cooling platform 410, 420. For example, selecting the user input element 514 may activate one or more cooling units (e.g., thermoelectric coolers) to start decreasing a temperature of a cooling platform 410, 420. Alternatively, selecting the user input element 514 may deactivate one or more components of the apparatus.

In some embodiments, a cooling cycle is automatically initiated when a container 412 and/or one or more slides 200 are detected by the apparatus 400, for example using one or more sensors positioned in an aperture 408 or in a container 412.

FIG. 18B shows a table 600 describing various functionality of display 404. For example, if optical indicator 512 shows white, the apparatus 400 may need to be restarted or there is no container 412 in a cooling platform 410, 420 (e.g., see Row A). In some embodiments, if the optical indicator 512 is slowly flashing green, the apparatus 400 has detected a presence of the container 412 and a temperature of the cooling platform 410, 420 is decreasing (e.g., see Row B). In some embodiments, if the optical indicator 512 is steadily showing green, it is appropriate to add one or more slides 200 to the container 412, which is at a pre-determined temperature (e.g., see Row C). In some embodiments, if the optical indicator 512 is slowly flashing another color (e.g., orange or blue), a timer is being started and indicates that a user should deposit one or more slides 200 into the container 412 and select user input element 514 (e.g., see Row D) to initiate a cooling cycle. In some embodiments, if the optical indicator 512 is steadily showing another color (e.g., orange or blue), the cooling cycle is complete and the container 412 and/or one or more slides 200 should be removed (e.g., see Row E). In some embodiments, if the optical indicator 512 is flashing another color at an increased frequency (e.g., fast or rapid flashing), a container 412 and/or one or more slides 200 remain in the apparatus 400 after a cooling cycle is complete (e.g., see Row F). In some embodiments, if one optical indicator 512 shows red and a second optical indicator 512 shows another color, the container 412 and/or one or more slides 200 have remained in the apparatus 400 for over a threshold period of time (e.g., 30 minutes, 1 hour, 2 hours, 3 hours, 4 hours, or beyond what is recommended) (e.g., see Row G). In some embodiments, if the optical indicator 512 shows red, the apparatus 400 may be experiencing a hardware or software malfunction (e.g., see Row H).

In some embodiments, the display 404 or apparatus 400 may further include a speaker. The speaker may provide acoustic feedback to a user of the apparatus 400. For example, the speaker may emit one or more beeps at varying intensity or frequency to indicate a status of a container 412, one or more slides 200, or cooling platforms 410, 420.

The systems and methods of the embodiment described herein and variations thereof may be embodied and/or implemented at least in part as a machine configured to receive a computer-readable medium storing computer-readable instructions. The instructions are preferably executed by computer-executable components integrated with the system and one or more portions of the processor in an automatic slide staining system and/or apparatus for automatically cooling a slide. The instructions can be stored on any suitable computer-readable media such as RAMs, ROMs, flash memory, EEPROMs, optical devices (e.g., CD or DVD), hard drives, floppy drives, or any suitable device. The computer-executable component is preferably a general or application-specific processor, but any suitable dedicated hardware or hardware/firmware combination can alternatively or additionally execute the instructions.

As used in the description and claims, the singular form “a”, “an” and “the” include both singular and plural references unless the context clearly dictates otherwise. For example, the term “a slide” may include, and is contemplated to include, a plurality of slides. At times, the claims and disclosure may include terms such as “a plurality,” “one or more,” or “at least one;” however, the absence of such terms is not intended to mean, and should not be interpreted to mean, that a plurality is not conceived.

The term “about” or “approximately,” when used before a numerical designation or range (e.g., to define a temperature), indicates approximations which may vary by (+) or (−) 5%, 1% or 0.1%. All numerical ranges provided herein are inclusive of the stated start and end numbers. The term “substantially” indicates mostly (i.e., greater than 50%) or essentially all of a device, substance, or composition.

As used herein, the term “comprising” or “comprises” is intended to mean that the devices, systems, and methods include the recited elements, and may additionally include any other elements. “Consisting essentially of” shall mean that the devices, systems, and methods include the recited elements and exclude other elements of essential significance to the combination for the stated purpose. Thus, a system or method consisting essentially of the elements as defined herein would not exclude other materials, features, or steps that do not materially affect the basic and novel characteristic(s) of the claimed disclosure. “Consisting of” shall mean that the devices, systems, and methods include the recited elements and exclude anything more than a trivial or inconsequential element or step. Embodiments defined by each of these transitional terms are within the scope of this disclosure.

The examples and illustrations included herein show, by way of illustration and not of limitation, specific embodiments in which the subject matter may be practiced. Other embodiments may be utilized and derived therefrom, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A system for automatically staining slides, the system comprising:
a slide management subsystem comprising:
a slide holder configured to receive a slide, and
a first cooling unit configured to maintain the slide at a temperature between −1° C. and −3° C.;
a reagent management subsystem comprising:
a rotatable support configured to receive a receptacle holding a reagent, and
a second cooling unit configured to maintain the reagent at a temperature between −1° C. and 6° C.; and
a fluid dispenser configured to uptake the reagent from the receptacle and dispense the reagent to the slide.

2. The system of claim 1, wherein the slide holder is sized and shaped to receive a slide clip coupled to the slide, wherein the slide clip is configured to create a capillary gap between the slide slip and the slide.

3. The system of claim 2, wherein the capillary gap between the slide clip and the slide is between 50 and 200 micrometers.

4. The system of claim 2, wherein the slide holder comprises a material configured to maintain the slide at a temperature between −1° C. and −3° C.

5. The system of claim 4, wherein the material comprises one or more of: copper, aluminum, steel, iron, and porcelain.

6. The system of claim 1, wherein the fluid dispenser is moveable between the rotatable support and the slide holder to deliver the reagent to the slide.

7. The system of claim 1, further comprising a housing, wherein the slide management subsystem and the reagent management subsystem are contained within the housing.

8. The system of claim 1, wherein the first cooling unit comprises a thermoelectric cooler.

9. The system of claim 1, wherein the second cooling unit comprises a thermoelectric cooler.

9. (canceled)

10. The system of claim 1, wherein the rotatable support is rotatable between 35° and 45° in 0.1 to 1 second.

11. The system of claim 1, wherein the rotatable support comprises a carousel.

12. The system of claim 1, wherein the fluid dispenser is configured to align with a longitudinal axis of the slide when the slide is positioned in the slide holder.

13. The system of claim 1, wherein the slide management subsystem further comprises one or more additional slide holders, wherein each additional slide holder is configured to receive an additional slide.

14. The system of claim 1, wherein the rotatable support comprises a pocket configured to receive the receptacle.

15. The system of claim 1, further comprising:
a processor communicatively coupled to the fluid dispenser and the rotatable support; and
a computer-readable medium having non-transitory, processor-executable instructions stored thereon, wherein execution of the instructions causes the processor to perform a method comprising:
receiving a user input to initiate a cell staining protocol;
uptaking the reagent from the rotatable support;
dispensing the reagent to the slide; and
incubating the slide with the reagent for a pre-determined period of time.

16. The system of claim 15, wherein the method executed by the processor further comprises repeating: uptaking, dispensing, and incubating until the cell staining protocol is complete.

17. The system of claim 15, wherein the method executed by the processor further comprises aligning the fluid dispenser with a second slide.

18. The system of claim 15, wherein the method executed by the processor further comprises rotating the rotatable support to align a second reagent with the fluid dispenser.

19. The system of claim 15, wherein the method executed by the processor further comprises moving the fluid dispenser between the rotatable support and the slide or a second slide.

20. The system of claim 15, further comprising a display configured to receive the user input.

21-35. (canceled)
